(19) United States
(12) Patent Application Publication
(10) Pub. No.: US 2022/0306022 A1
(43) Pub. Date: Sep. 29, 2022

(54) BUMPER REINFORCEMENT

(71) Applicants: TOYOTA JIDOSHA KABUSHIKI KAISHA, Toyota-shi Aichi-ken (JP); SUBARU CORPORATION, Tokyo (JP)

(72) Inventor: Tomohiro Matsumoto, Shibuya-ku Tokyo (JP)

(21) Appl. No.: 17/700,754

(22) Filed: Mar. 22, 2022

(30) Foreign Application Priority Data
Mar. 24, 2021 (JP) 2021-049809

(51) Int. Cl. B60R 19/18; B60R 19/34

(52) U.S. Cl. CPC B60R 19/18; B60R 19/34; B60R 2019/186

(57) ABSTRACT

A bumper reinforcement includes a base portion that extends in a vehicle-width direction, and a protruding portion that is attached to at least one end of the base portion in an up-down direction, and that protrudes in a direction away from the base portion in the up-down direction. A crash box is disposed on a vehicle inner side of the base portion. The protruding portion has at least one of (A) a length in a vehicle front-rear direction that is longer than the length in the vehicle front-rear direction of the base portion, and (B) a plate thickness that is greater than the plate thickness of the base portion.

### CROSS-REFERENCE TO RELATED APPLICATION

This application claims priority to Japanese Patent Application No. 2021-049809 filed on Mar. 24, 2021, incorporated herein by reference in its entirety.

### BACKGROUND

### 1. Technical Field

The present specification discloses a bumper reinforcement installed at end portions of a vehicle in a front-rear direction.

### 2. Description of Related Art

Japanese Unexamined Patent Application Publication No. 2003-312400 (JP 2003-312400 A) discloses a bumper reinforcement that is attached to a crash box. The bumper reinforcement has a tubular shape. The length of the bumper reinforcement in an up-down direction matches the length of the crash box in the up-down direction.

### SUMMARY

In the above technology, when the vehicle encounters a collision with regard to a position in the up-down direction at which the crash box is not disposed, there are cases in which the bumper reinforcement is not able to bear the load of the collision.

The present specification provides technology in which a bumper reinforcement is capable of bearing the load of a collision with regard to a position in an up-down direction at which a crash box is not disposed.

A bumper reinforcement having a tubular shape and extending in a vehicle-width direction is disclosed in the present specification. The bumper reinforcement includes a base portion that extends in a vehicle-width direction, and a protruding portion that is attached to at least one end of the base portion, and that protrudes in a direction away from the base portion in the up-down direction. A crash box is disposed on a vehicle inner side of the base portion. The protruding portion has at least one of (A) a length in a vehicle front-rear direction that is longer than a length in the vehicle front-rear direction of the base portion, and (B) a plate thickness that is greater than a plate thickness of the base portion.

According to the above configuration, load of a collision applied to a vehicle at a position in the up-down direction at which the crash box is not disposed can be borne by the protruding portion of the bumper reinforcement. The protruding portion includes at least one of a portion that is longer in the vehicle front-rear direction than the base portion, and a portion that is greater in plate thickness than the base portion, and accordingly the second moment of area in the vehicle front-rear direction can be made to be greater than that of the base portion. Thus, deformation of the protruding portion can be suppressed when bearing the load of a collision, as compared to when the shape of the protruding portion is a shape in which the base portion is simply extended in the up-down direction. As a result, deformation of the protruding portion when bearing the load of a collision can be suppressed, even though no crash box is disposed on the rear side of the protruding portion.

Technical elements of the bumper reinforcement disclosed in the present specification are listed below. Note that the following technical elements are each independently exhibit utility.

In the bumper reinforcement, a reinforcing wall that extends in the vehicle front-rear direction may be disposed, on an inner side of the bumper reinforcement, between the base portion and the protruding portion.

According to this configuration, deformation of the protruding portion can be suppressed by the reinforcing wall.

In the bumper reinforcement, the protruding portion may include a particular portion that is longer in the vehicle front-rear direction than the base portion, and the particular portion may extend further to the vehicle inner side than the base portion.

According to this configuration, the particular portion that is longer in the vehicle front-rear direction than the base portion can be formed on the protruding portion, without extending the bumper reinforcement to the bumper side. This does away the need to widen the gap between the base portion of the bumper reinforcement and the bumper.

In the bumper reinforcement, the particular portion may be an inclined face that extends from the one end of the base portion in a direction away from the base portion, and inclines to the vehicle inner side.

According to this configuration, disposing the inclined face enables the length of the particular portion in the vehicle front-rear direction to be gradually lengthened from the base portion. This keeps a step from being formed at the boundary portion of the base portion and the particular portion. As a result, concentration of stress can be suppressed from occurring at the boundary portion of the base portion and the particular portion under load of a collision.

In the bumper reinforcement, the protruding portion may be attached to both ends of the base portion in the up-down direction, and the protruding portion situated on an upper end of the base portion may have a shape that is obtained by inverting, in the up-down direction, a shape of the protruding portion situated on a lower end of the base portion.

In the bumper reinforcement, the crash box may be not disposed on a vehicle inner side of the protruding portion.

Another aspect of the disclosure provides a bumper reinforcement having a tubular shape and extending in a vehicle-width direction. The bumper reinforcement includes a base portion that extends in the vehicle-width direction, and a protruding portion that is attached to at least one end of the base portion in an up-down direction, and that protrudes in a direction away from the base portion in the up-down direction. A crash box is disposed on a vehicle inner side of the base portion. A plate thickness of the protruding portion is greater than a plate thickness of the base portion. A length of the protruding portion in a vehicle front-rear direction is the same as a length of the base portion in the vehicle front-rear direction.

In the bumper reinforcement, the crash box may be not disposed on a vehicle inner side of the protruding portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating part of a rear side of a vehicle according to a first embodiment;

FIG. 2 is a plan view of a bumper reinforcement and a crash box according to the first embodiment;

FIG. 3 is a cross-sectional view illustrating cross-section in FIG. 2;

FIG. 4 is a cross-sectional view illustrating cross-section according to a second embodiment; and

FIG. 5 is a cross-sectional view illustrating cross-section according to a third embodiment.

### DETAILED DESCRIPTION OF EMBODIMENTS

### First Embodiment

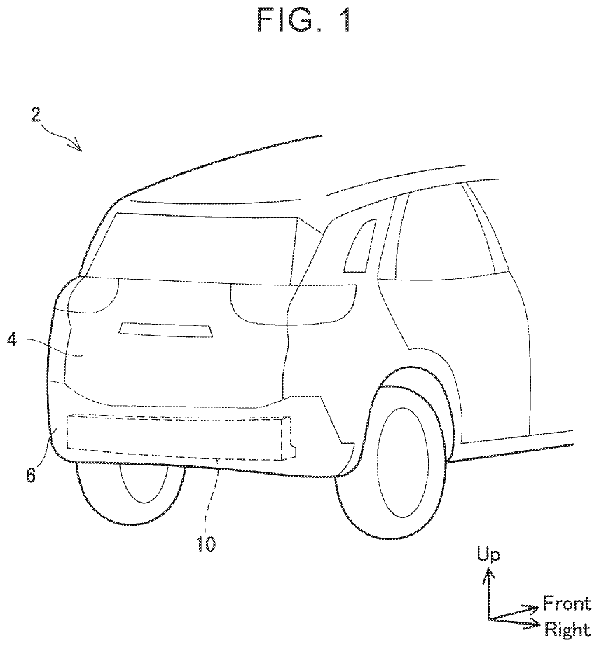

As illustrated in FIG. 1, a bumper reinforcement 10 according to the present embodiment is disposed at a rear end portion of a vehicle 2. The bumper reinforcement 10 is disposed on a vehicle inner side of a rear bumper 6 disposed at a vehicle rear end, i.e., on a vehicle front side of the rear bumper 6. The bumper reinforcement 10 bears the load when the vehicle 2 encounters a rear-end collision, and suppresses deformation of the vehicle 2.

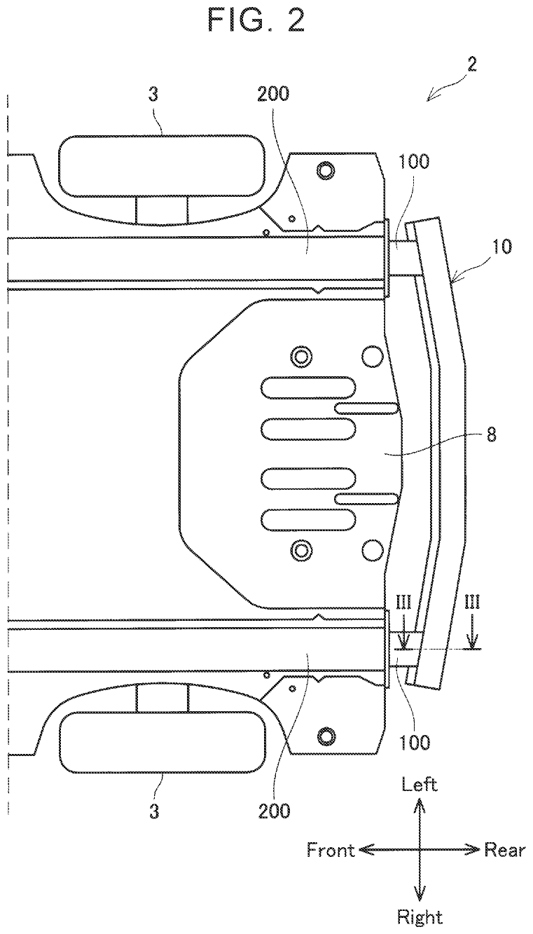

As illustrated in FIG. 2, the bumper reinforcement 10 extends in a vehicle-width direction, i.e., in a right-left direction. A middle portion in the vehicle-width direction of the bumper reinforcement 10 extends parallel to the vehicle-width direction, and each of both end portions thereof in the vehicle-width direction incline forward in the vehicle. The bumper reinforcement 10 is linked to crash boxes 100 at both end portions in the vehicle-width direction. The bumper reinforcement 10 is fixed to the crash boxes 100 by bolting, for example. The crash boxes 100 each has a generally square tubular shape, of which the axial direction is parallel to a vehicle front-rear direction. Front ends of the crash boxes 100 are linked to rear ends of side members 200. The side members 200 are both end portions in the vehicle-width direction of a floor panel 8, and are attached at the vehicle inner side from wheels 3.

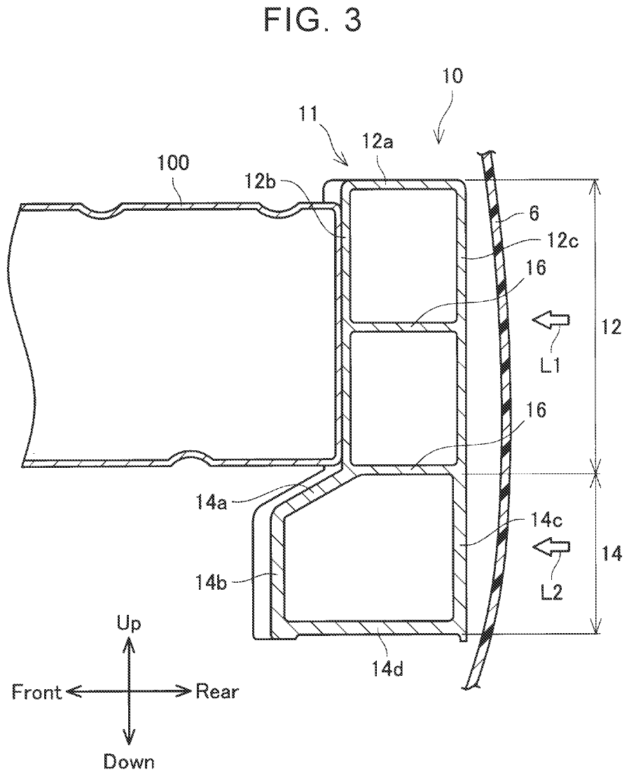

As illustrated in FIG. 3, the bumper reinforcement 10 is disposed with a slight gap between itself and the rear bumper 6. The bumper reinforcement 10 has an outer peripheral wall 11 that has a generally hexagonal tubular shape. The bumper reinforcement 10 is fabricated by extrusion of aluminum alloy. In the bumper reinforcement 10, cross-sections perpendicular to the axial direction of the outer peripheral wall 11 have the same cross-sectional shape, over the entire length in the vehicle-width direction. The bumper reinforcement 10 has a plurality of reinforcing walls 16 that is disposed between a pair of wall portions of the outer peripheral wall 11 that face each other in the vehicle front-rear direction. Each of the reinforcing walls 16 has a flat-plate form. The reinforcing walls 16 are disposed over the entire length in the vehicle-width direction. The reinforcing walls 16 are disposed from the front end side of the bumper reinforcement 10 to the rear end side thereof in the vehicle front-rear direction, parallel to the vehicle front-rear direction.

The bumper reinforcement 10 is provided with a base portion 12 and a protruding portion 14. The base portion 12 is a portion from an upper end of the bumper reinforcement 10, i.e., the upper end of the outer peripheral wall 11, to a reinforcing wall 16 disposed at generally the same height as a lower end of the crash box 100, in an up-down direction. The base portion 12 has a rectangular shape in a cross-section taken perpendicular to the vehicle-width direction. An upper wall 12a disposed at the upper end of the base portion 12 is situated somewhat upward from the upper end of the crash box 100. A front wall 12b that is perpendicular to the vehicle front-rear direction is disposed at the front end of the upper wall 12a. A rear wall 12c that is perpendicular to the vehicle front-rear direction and is parallel to the front wall 12b is disposed at the rear end of the upper wall 12a.

The reinforcing walls 16 are disposed perpendicular to the front wall 12b and the rear wall 12c, between the front wall 12b and the rear wall 12c. The lower end of the base portion 12 is situated somewhat downward from the lower end of the crash box 100. That is to say, the crash box 100 is disposed in the vehicle forward direction from the base portion 12, over the general entire length in the up-down direction thereof. A reinforcing wall 16 is disposed at an intermediate position of the base portion 12 in the up-down direction. The upper wall 12a, the front wall 12b, the rear wall 12c, and the reinforcing walls 16 have the same plate thickness as each other.

One reinforcing wall 16 is disposed at the lower end of the base portion 12. The protruding portion 14 that protrudes downward from the lower end of the base portion 12 is disposed downward from the base portion 12. The one reinforcing wall 16 is disposed between the base portion 12 and the protruding portion 14. The protruding portion 14 is disposed over the entire length of the bumper reinforcement 10 in the vehicle-width direction. The protruding portion 14 is situated downward from the lowermost-situated reinforcing wall 16. A rear wall 14c situated at the rear end of the protruding portion 14 is disposed as an extension of the rear wall of the base portion 12. The protruding portion 14 has, at the front end thereof, an inclined wall (inclined face) 14a that has a flat-plate form, inclining forward from the lower end of the base portion 12. A front wall 14b is linked to the lower end of the inclined wall 14a. The front wall 14b is disposed in parallel to the rear wall 14c and the up-down direction. The front wall 14b and the rear wall 14c are linked through a lower wall 14d that extends in the vehicle front-rear direction, at the lower ends thereof. The lower wall 14d has a flat-plate form, disposed perpendicular to the up-down direction. The length of the protruding portion 14 in the vehicle front-rear direction is longer than the length of the base portion 12 in the vehicle front-rear direction.

The inclined wall 14a, the front wall 14b, the rear wall 14c, and the lower wall 14d are included in the outer peripheral wall 11. The outer peripheral wall 11 is configured of the inclined wall 14a, the front wall 14b, the rear wall 14c, the lower wall 14d, the upper wall 12a, the front wall 12b, and the rear wall 12c.

The plate thicknesses of the inclined wall 14a, the front wall 14b, the rear wall 14c, and the lower wall 14d configuring the protruding portion 14 are the same as each other. The plate thicknesses of the inclined wall 14a, the front wall 14b, the rear wall 14c, and the lower wall 14d (hereinafter referred to simply as “plate thickness of protruding portion 14”) are greater than the plate thicknesses of the upper wall 12a, the front wall 12b, and the rear wall 12c configuring the base portion 12, and the reinforcing walls 16 (hereinafter referred to simply as “plate thickness of base portion 12”).

When the vehicle 2 encounters a rear-end collision by a vehicle or the like, the rear bumper 6 is deformed by the load of the collision in the forward direction, and load is applied to the bumper reinforcement 10 in some cases. When the load of the collision is applied at the height at which the crash box 100 is disposed, as indicated by an arrow representing a load L1, the load L1 is borne by the bumper reinforcement 10 and the crash box 100. Accordingly, the bumper reinforcement 10 can be suppressed from being greatly displaced forward under the load. As a result, deformation of the rear bumper 6 is suppressed.

On the other hand, when the load of the collision is applied at a height at which the crash box 100 is not disposed, as indicated by an arrow representing a load L2, the bumper reinforcement 10 has no member in the forward direction of the vehicle on the extension of the direction of the load L2 that can bear the load. Accordingly, assuming a case in which the protruding portion 14 has the same length as the base portion 12 in the vehicle front-rear direction, and also has the same plate thickness as the base portion 12, the displacement of the bumper reinforcement 10 when bearing the load L2 is greater than the displacement of the bumper reinforcement 10 when bearing the load L1, even though the load L1 and the load L2 are equal.

The protruding portion 14 forms a hollow pipe shape in combination with the upward reinforcing wall 16. Accordingly, the longer the length of the protruding portion 14 is in the vehicle front-rear direction, the greater the second moment of area in the front-rear direction (hereinafter referred to simply as “second moment of area”) is. The protruding portion 14 is longer in the front-rear direction as compared to the base portion 12. Accordingly, the second moment of area of the protruding portion 14 can be increased as compared to a case of fabricating the protruding portion 14 with the same length in the front-rear direction as the base portion 12. Also, the thicker the plate thickness is, the greater the second moment of area of the protruding portion 14 is. The plate thickness of the protruding portion 14 is greater in comparison with the plate thickness of the base portion 12. Accordingly, the second moment of area of the protruding portion 14 can be increased as compared to a case of simply fabricating the protruding portion 14 with the same plate thickness as the base portion 12. According to this configuration, displacement of the protruding portion 14 can be suppressed. As a result, deformation of the rear bumper 6 can be suppressed.

When the rear bumper 6 becomes deformed and bulges upward, the rear bumper 6 interferes with a lower end portion of a luggage door 4, rendering the luggage door 4 unopenable in some cases. Suppressing deformation of the rear bumper 6 by the bumper reinforcement 10 enables situations in which the luggage door 4 becomes unopenable to be circumvented.

For example, the bumper reinforcement 10 is particularly useful for a vehicle 2 of which the vehicle height is relatively high. When the vehicle height is high, the position of the floor panel 8 also is high, and the positions of the side members 200 and the crash boxes 100 also are high. When the vehicle 2 encounters a rear-end collision by a vehicle or the like with a relatively low vehicle height, there are cases in which the rear bumper 6 receives the collision at a position lower than the crash boxes 100, and the load is applied at the position of the load L2. The bumper reinforcement 10 can suppress the bumper reinforcement 10 and the rear bumper 6 from being greatly deformed in such low-position collisions. Particularly, suppressing deformation of the protruding portion 14 under relatively small loads such as when the vehicle 2 is rear-ended by another vehicle at a low speed enables deformation of the rear bumper 6 to be suppressed.

A reinforcing wall 16 is disposed at the upper end of the protruding portion 14. The protruding portion 14 and the reinforcing wall 16 form a tubular shape. Thus, the protruding portion 14 can be reinforced by the reinforcing wall 16. Note that in a modification, one or more reinforcing walls may be disposed in the protruding portion 14. The one or more reinforcing walls may extend from at least one of the inclined wall 14a and the front wall 14b to the rear wall 14c, and may be parallel to the front-rear direction or may be inclined. Also, the plate thickness of the reinforcing wall 16 situated at the upper end of the protruding portion 14 may be the same as the plate thickness of the protruding portion 14.

Downward from the crash box 100, the protruding portion 14 extends further forward in the vehicle than the base portion 12, i.e. to the vehicle inner side. In a normal vehicle 2, there are no component parts disposed downward from the crash box 100, and there is an open space. Accordingly, there is no need to reposition component parts of the vehicle 2 in order to secure space for the length of the protruding portion 14 in the vehicle front-rear direction. Also, the protruding portion 14 extends to the vehicle inner side. Accordingly, there is no need to dispose the rear bumper 6 away from the bumper reinforcement 10 in order to secure space for the length of the protruding portion 14 in the vehicle front-rear direction.

In the protruding portion 14, the inclined wall 14a is inclined downward toward the vehicle inner side from the lower end of the base portion 12, i.e., is inclined to the vehicle front side. As a result, a step can be kept from being formed at the boundary portion of the protruding portion 14 and the base portion 12. Thus, concentration of stress can be suppressed from occurring at the boundary portion of the base portion 12 and the protruding portion 14 under load of a collision.

### Second Embodiment

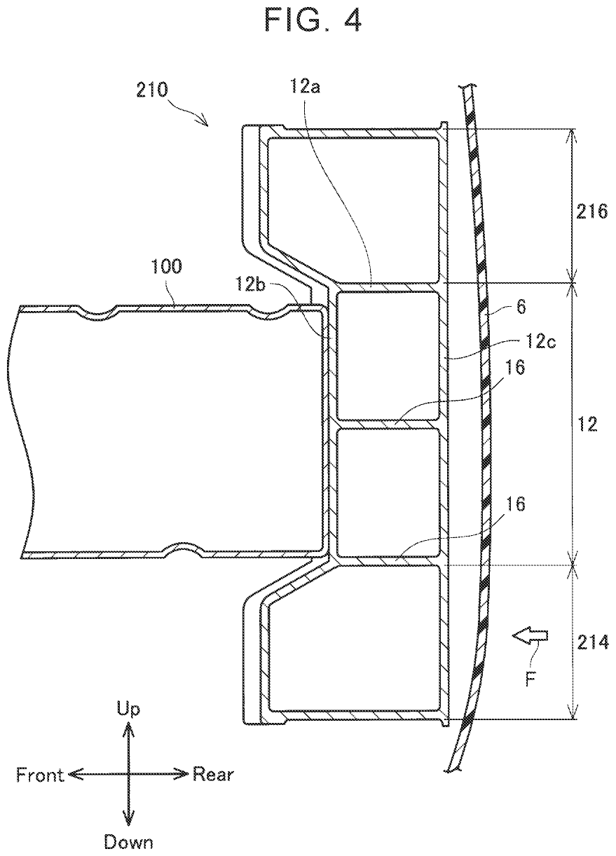

As illustrated in FIG. 4, a bumper reinforcement 210 is provided with a protruding portion 214 instead of the protruding portion 14. The bumper reinforcement 210 is also provided with a protruding portion 216. Otherwise, the configuration of the bumper reinforcement 210 is the same as the configuration of the bumper reinforcement 10.

When comparing the protruding portion 214 with the protruding portion 14, the plate thickness of the protruding portion 214 is thinner than the plate thickness of the protruding portion 14, and is the same as the plate thickness of the base portion 12. Otherwise, the configuration of the protruding portion 214 is the same as the configuration of the protruding portion 14.

The protruding portion 216 is situated upward from the upper wall 12a at the upper end of the base portion 12. The shape of the protruding portion 216 is a shape in which the protruding portion 214 is inverted in the up-down direction. According to this configuration, deformation of the bumper reinforcement 210 can be suppressed with regard to loads upward from the base portion 12.

Note that in a modification, the plate thicknesses of the protruding portion 214 and the protruding portion 216 may be the same as the plate thickness of the protruding portion 14. Also, the bumper reinforcement 210 may be without one of the protruding portion 214 and the protruding portion 216.

### Third Embodiment

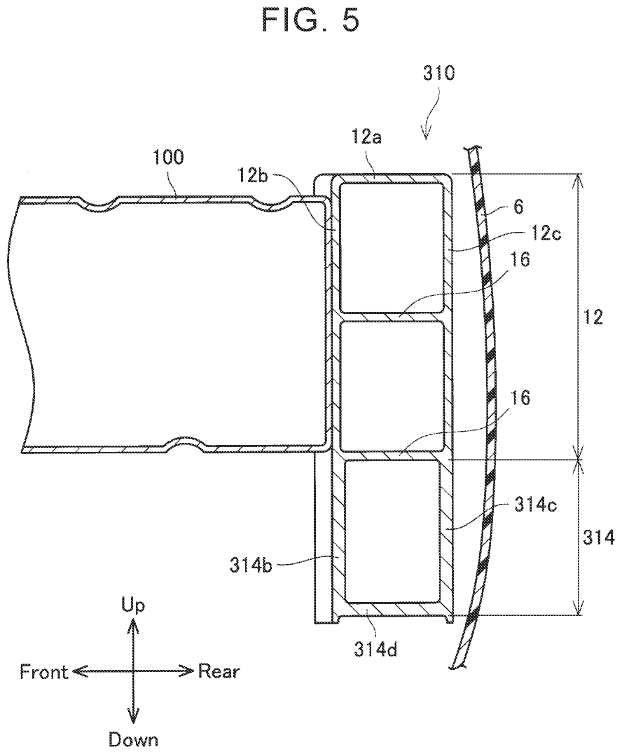

As illustrated in FIG. 5, a bumper reinforcement 310 is provided with a protruding portion 314 instead of the protruding portion 14. Otherwise, the configuration of the bumper reinforcement 310 is the same as the configuration of the bumper reinforcement 10.

The protruding portion 314 has a front wall 314b, a rear wall 314c, and a lower wall 314d. The rear wall 314c is the same as the rear wall 14c. The front wall 314b is disposed as an extension of the front wall 12b. That is to say, the length of the protruding portion 314 in the vehicle front-rear direction is the same as the length of the base portion 12 in the vehicle front-rear direction. The lower wall 314d is linked to the front wall 314b and the rear wall 314c at the lower end of the protruding portion 314. The plate thickness of the protruding portion 314 is the same as the plate thickness of the protruding portion 14.

Note that in a modification, the bumper reinforcement 310 may be provided with a protruding portion of the same configuration as the protruding portion 314 upward from the base portion 12.

While specific examples of the disclosure have been described in detail above, these are merely exemplary, and do not limit the scope of the claims. The technology described in the claims includes various modifications and alternations of the specific examples exemplified above.

The protruding portion 14 does not have to be disposed over the entire length of the bumper reinforcement 10 in the vehicle-width direction, i.e., the vehicle right-left direction. For example, the protruding portion 14 may be disposed only at a portion in the vehicle-width direction at which the probability of a collision is relatively high. This holds true for the protruding portions 214, 216, and 314 as well.

The protruding portion 14 may extend further rearward in the vehicle than the base portion 12. This holds true for the protruding portions 214 and 216 as well.

The bumper reinforcements 10, 210, and 310 may be disposed on the vehicle inner side from a front bumper at a front end of the vehicle.

Cross-sections of the bumper reinforcement 10 perpendicular to the vehicle-width direction do not have to have the same cross-sectional shape over the entire length in the vehicle-width direction. For example, a cross-sectional shape that improves the second moment of area may be disposed in at least one of the base portion 12 and the protruding portion 14, at a portion in the vehicle-width direction at which the probability of a collision is relatively high. This holds true for the bumper reinforcements 210 and 310, as well. For example, a portion in the vehicle-width direction of the protruding portion 14 at which the probability of a collision is relatively high may have the cross-sectional shape of the protruding portion 14, while other portions have the cross-sectional shape of the protruding portion 214 or the cross-sectional shape of the protruding portion 314.

Also, the technical elements described herein or illustrated in the drawings exhibit technical utility alone or in various combinations, and are not limited to the combination described in the claims as filed. Also, the technology exemplified herein or illustrated in the drawings may simultaneously achieve a plurality of objects, and exhibit technical utility by achieving one of the objects.

What is claimed is:

1. A bumper reinforcement having a tubular shape and extending in a vehicle-width direction, the bumper reinforcement comprising:
a base portion that extends in the vehicle-width direction; and
a protruding portion that is attached to at least one end of the base portion in an up-down direction, and that protrudes in a direction away from the base portion in the up-down direction,
wherein a crash box is disposed on a vehicle inner side of the base portion, and
wherein the protruding portion has at least one of
(A) a length in a vehicle front-rear direction that is longer than a length in the vehicle front-rear direction of the base portion, and
(B) a plate thickness that is greater than a plate thickness of the base portion.

2. The bumper reinforcement according to claim 1, wherein a reinforcing wall that extends in the vehicle front-rear direction is disposed, on an inner side of the bumper reinforcement, between the base portion and the protruding portion.

3. The bumper reinforcement according to claim 1, wherein the protruding portion includes a particular portion that is longer in the vehicle front-rear direction than the base portion, and the particular portion extends further to the vehicle inner side than the base portion.

4. The bumper reinforcement according to claim 3, wherein the particular portion is an inclined face that extends from the one end of the base portion in the direction away from the base portion, and inclines to the vehicle inner side.

5. The bumper reinforcement according to claim 1, wherein the protruding portion is attached to both ends of the base portion in the up-down direction, and the protruding portion situated on an upper end of the base portion has a shape that is obtained by inverting, in the up-down direction, a shape of the protruding portion situated on a lower end of the base portion.

6. The bumper reinforcement according to claim 1, wherein the crash box is not disposed on a vehicle inner side of the protruding portion.

7. A bumper reinforcement having a tubular shape and extending in a vehicle-width direction, the bumper reinforcement comprising:
a base portion that extends in the vehicle-width direction; and
a protruding portion that is attached to at least one end of the base portion in an up-down direction, and that protrudes in a direction away from the base portion in the up-down direction,
wherein a crash box is disposed on a vehicle inner side of the base portion,
wherein a plate thickness of the protruding portion is greater than a plate thickness of the base portion, and
wherein a length of the protruding portion in a vehicle front-rear direction is the same as a length of the base portion in the vehicle front-rear direction.

8. The bumper reinforcement according to claim 7, wherein the crash box is not disposed on a vehicle inner side of the protruding portion.
